(19) United States
(12) Patent Application Publication
(10) Pub. No.: US 2004/0032402 A1
(43) Pub. Date: Feb. 19, 2004

(54) Switch device for portable electronics

(76) Inventor: Ming-Jen Kuo, Taipei (TW)

Correspondence Address: HARNESS, DICKEY & PIERCE, P.L.C., P.O. BOX 8910, RESTON, VA, 20195, US

(21) Appl. No.: 10/222,581

(22) Filed: Aug. 19, 2002

(51) Int. Cl. G09G 5/00

(52) U.S. Cl. 345/179

(57) ABSTRACT

A switch device for portable electronics is disclosed. A switch circuit is provided inside a portable electronic product and a touch-control pen hidden inside the electronic product is used as the ON/OFF device of the switch circuit. When a user draws the touch-control pen and starts the switch circuit, the electronic product is immediately turned on; when the user inserts the touch-control pen into the electronic product, the switch circuit is off so that the electronic product shuts down. According to the invention, the switches of the portable electronics are controlled by the drawing and inserting of the touch-control pen.

### BACKGROUND OF THE INVENTION

1. Field of Invention

The invention relates to a switch for portable electronic devices and, in particular, to a portable electronic device that uses a touch-control pen hidden inside the portable electronic product as the switch.

2. Related Art

In the design of switches for normal portable electronics, there are usually a main power button and a screen touch-control switch. The function of the main power button is to turn off the electronic device so that electric power is not consumed when the portable electronic device is not in use. The purpose of installing a screen touch-control switch is to allow the user to use a touch-control pen normally hidden inside the electronic product to start the electronic device by touching the screen. When the electronic device is on, the user can also use the touch-control pen to touch the screen and turn off the electronic device. The electronic device then enters a standby state.

However, this design has the following drawback. First, the user has to use a touch-control pen to touch a screen, waking up an electronic device from its standby state, and then perform various operations using the same touch-control pen on the screen. In fact, when the user pulls out the touch-control pen hidden in the pen slot of the electronic device, this action already implies that the user wants to use the electronic device. Thus, the user does not need to touch the screen using the touch-control pen. Furthermore, if the user carelessly touches the screen to turn off the electronic device, it is likely to happen that the user thinks the device is already turned off and when touch-control pen is put away inside the provided pen slot but actually the electronic device is still on. This will result in power waste. Therefore, for portable electronic device users, using a touch-control pen to touch the screen as turning on and off the device is an unnecessary operation, and the user has to worry whether the device is indeed turned off.

### SUMMARY OF THE INVENTION

In view of the foregoing complicated procedure, an objective of the invention is to provide a switch for portable electronic devices. A switch circuit is provided inside a portable electronic device, and a touch-control pen normally hidden inside the electronic device is used as an ON/OFF device of the switch circuit. When the user pulls out the touch-control pen from the electronic device, the switch circuit is initiated so that the electronic device is immediately turned on. When the user inserts the touch-control pen into the electronic device, the switch circuit is off so that the electronic device immediately shuts down. The touch-control pen has the function of a switch to turn on/off the portable electronic device.

### BRIEF DESCRIPTION OF THE DRAWINGS

The invention will become more fully understood from the detailed description given hereinbelow illustration only, and thus are not limitative of the present invention, and wherein:

FIG. 1 is a three-dimensional view of the invention;

FIG. 2 is another three-dimensional view of the invention;

FIG. 3 is a local magnified view of the invention using a photo-coupling interface as the switch device;

FIG. 4A is a local magnified view of the invention using a spring chip interface as the switch device, where the touch-control probe of the touch-control pen touches the spring chip interface; and

FIG. 4B is another local magnified view of the invention using a spring chip interface as the switch device, where the touch-control probe of the touch-control pen leaves the spring chip interface.

### DETAILED DESCRIPTION OF THE INVENTION

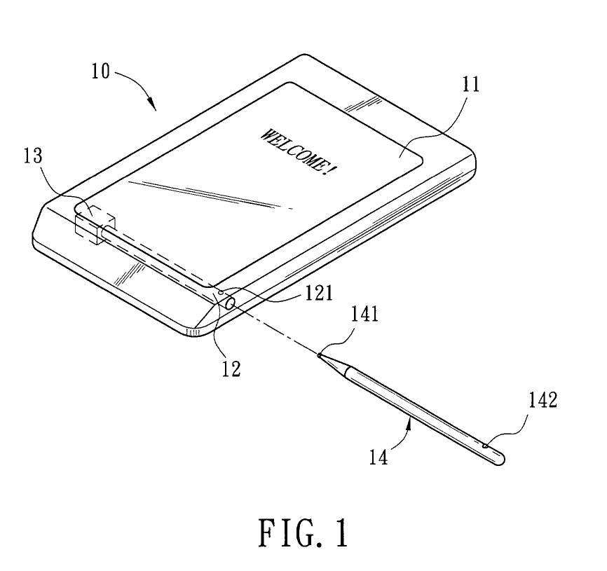

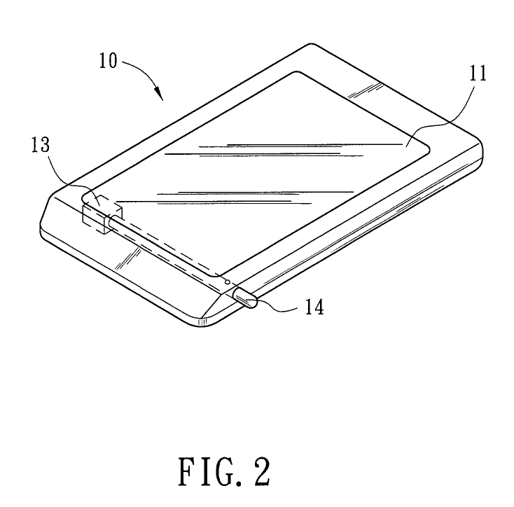

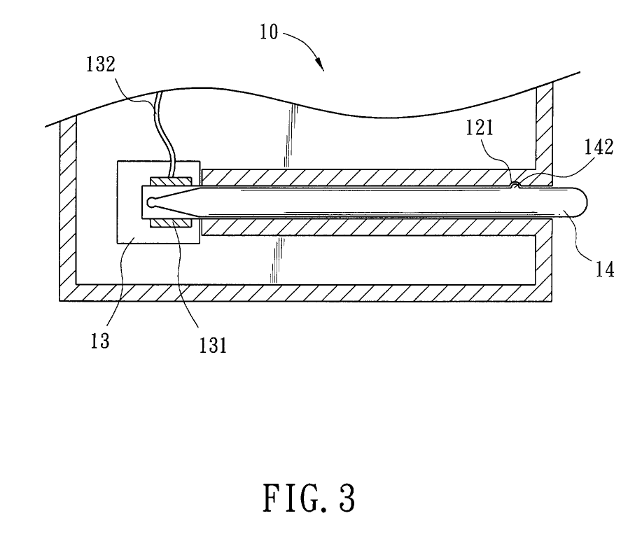

This specification discloses a switch device for portable electronic devices. Please refer to FIGS. 1 and 2 for three-dimensional views and FIG. 3 for a local magnified view of the invention. The invention has a screen 11 installed on a top surface for a user to input and read information. The portable electronic device 10 (here we take a personal digital assistant (PDA) as an example) is provided with a pen slot 12, which has at least one concave clit 121. At the inner end of the pen slot is provided with a switch circuit 13.

The pen slot 12 can accommodate a touch-control pen 14 for controlling the portable electronic device. One tip of the touch-control pen 14 has a touch-control probe 141 for touching the switch circuit 13 of the portable electronic device 10. The body of the touch-control pen has at least one protruding point 142. When the touch-control pen is put away into the pen slot 12 of the portable electronic device, the protruding point 142 will match with a concave slit 121 inside the pen slot for positioning the touch-control pen.

As shown in FIG. 1, a touch-control pen is pulled out from the pen slot, turning on the portable electronic device. On the other hand, FIG. 2 shows that the touch-control pen is in the pen slot and, therefore, the portable electronic device is off.

The switch circuit 13 of the portable electronic device has at least two types: photo-coupling interface and spring chip interface. FIG. 3 shows a switch circuit 13 with the photo-coupling interface 131. When the touch-control pen 14 is inserted into the pen slot 12 of the portable electronic device 10, the protruding point 142 stops at the concave slit 121 of the pen slot, ensuring that the touch-control pen is correctly positioned in the pen slot. At this moment, the front tip of the touch-control pen blocks the light transmission of the photo-coupling interface 131. This information is then sent to the starting device (not shown) of the portable electronic device 10 through a photo-coupling interface circuit 132, turning off the portable electronic device. Consequently, no data are displayed on the screen 11 (see FIG. 2).

When the user wants to use the portable electronic device 10, he or she only needs to pull out the touch-control pen 14 from the pen slot 12. The front tip of the touch-control pen 14 leaves the switch circuit of the photo-coupling interface 131. This information is sent to the starting device (not shown) of the portable electronic device 10. The portable electronic device 10 is thus started and a welcome message, for example, will show on the screen 11.

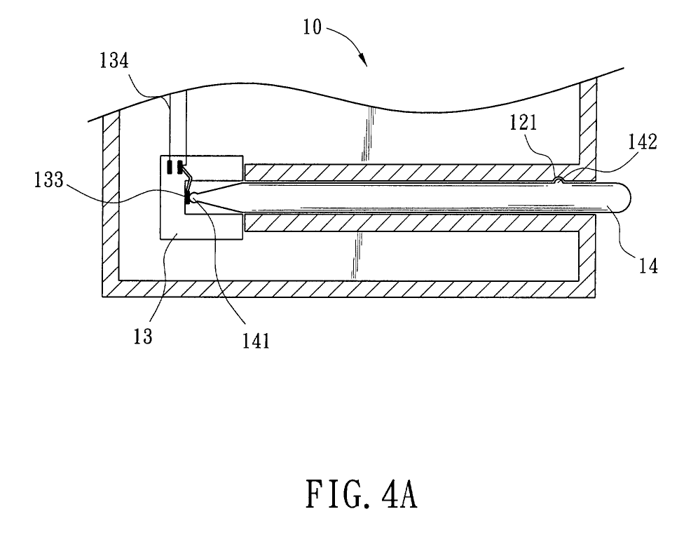

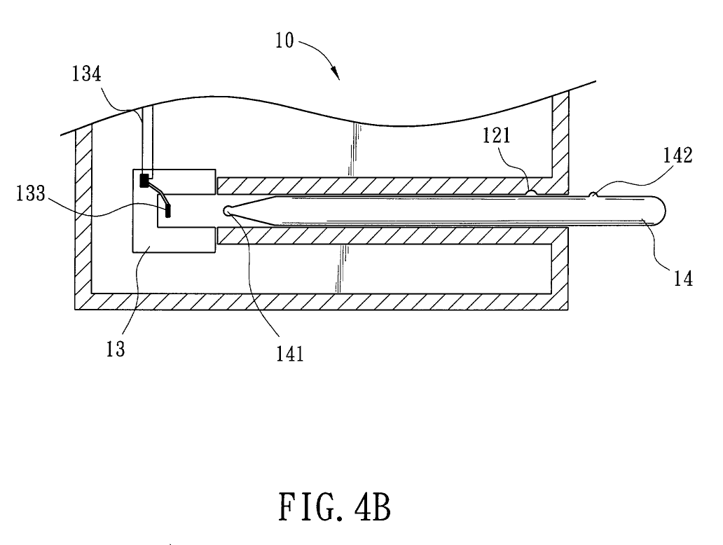

Please refer to FIGS. 4A and 4B for a switch circuit 13 using a spring chip interface 133. In FIG. 4A, the touch-control probe of the touch-control pen touches the spring chip interface, turning off the portable electronic device. In FIG. 4B, on the other hand, the touch-control probe of the touch-control pen leaves the spring chip interface, turning on the portable electronic device. More explicitly, when the touch-control pen 14 is inside the pen slot 12, the protruding point 142 of the touch-control pen stops at the concave slit 121 of the pen slot. This means that the touch-control pen is correctly positioned inside the pen slot. At the same time, the touch-control probe 141 of the touch-control pen depresses the spring chip interface 133, setting the spring chip interface 133 in a separate state and a spring chip interface circuit 134 in a disconnected state. Consequently, the portable electronic device is off and no data are displayed on the screen 11 (see FIG. 2).

When the user wants to use the portable electronic device 10, he or she only needs to pull out the touch-control pen 14 from the pen slot 12. The touch-control probe 141 of the touch-control pen 14 leaves the switch circuit of the spring chip interface 133. Due to the elastic restoration force, the spring chip interface circuit 134 becomes closed, thereby turning on the portable electronic device. The screen 11 is thus on and displays a welcome message (see FIG. 1).

Certain variations would be apparent to those skilled in the art, which variations are considered within the spirit and scope of the claimed invention.

What is claimed is:

1. A switch device of a portable electronic device, which is characterized in that: the portable electronic device contains a pen slot, a switch circuit and a touch-control pen, and the power switch of the portable electronic device is turned on when the touch-control pen is pulled out of the pen slot.

2. The switch device of a portable electronic device of claim 1, wherein the pen slot of the portable electronic device has at least one concave slit.

3. The switch device of a portable electronic device of claim 1, wherein the front tip of the touch-control pen has a touch-control probe for touching the switch circuit of the portable electronic device.

4. The switch device of a portable electronic device of claim 1, wherein the body of the touch-control pen has at least one protruding point.

5. The switch device of a portable electronic device of claim 1, wherein the touch-control pen is accommodated in the pen slot of the portable electronic device, the protruding point of the touch-control pen corresponds to a concave slit of the pen slot for positioning the touch-control pen in the pen slot.

6. The switch device of a portable electronic device of claim 1, wherein the switch circuit of the portable electronic device is provided around an inner end of the pen slot.

7. The switch device of a portable electronic device of claim 1, wherein the switch circuit of the portable electronic device is a photo-coupling interface.

8. The switch device of a portable electronic device of claim 7, wherein the switch device of the portable electronic device shuts down when the front end of the touch-control pen approaches the switch circuit of the photo-coupling interface.

9. The switch device of a portable electronic device of claim 7, wherein the switch device of the portable electronic device turns on when the front end of the touch-control pen leaves the switch circuit of the photo-coupling interface.

10. The switch device of a portable electronic device of claim 1, wherein the switch circuit of the portable electronic device is a spring chip interface.

11. The switch device of a portable electronic device of claim 10, wherein the switch device of the portable electronic device shuts down when the touch-control probe of the touch-control pen touches the switch circuit of the spring chip interface.

12. The switch device of a portable electronic device of claim 10, wherein the switch device of the portable electronic device turns on when the touch-control probe of the touch-control pen leaves the switch circuit of the spring chip interface.
